(19) United States
(12) Patent Application Publication
(10) Pub. No.: US 2021/0047039 A1
(43) Pub. Date: Feb. 18, 2021

(54) SYSTEM, METHOD AND DEVICE FOR ATTACHING A TOOL OR A PAYLOAD TO AN UNMANNED AERIAL VEHICLE

(71) Applicant: Volocopter GmbH, Brushsal (DE)

(72) Inventors: Francisco Javier INFANTE AGUIRRE, Munchen (DE); Nicolas STAUB, Munchen (DE)

(73) Assignee: Volocopter GmbH, Bruchsal (DE)

(21) Appl. No.: 16/904,990

(22) Filed: Jun. 18, 2020

(30) Foreign Application Priority Data
Aug. 15, 2019 (EP) 19191889.5

(51) Int. Cl. B64D 1/22; B64C 39/02; B64D 1/12

(52) U.S. Cl. CPC B64D 1/22; B64C 39/024; B64C 2201/027; B64C 2201/128; B64D 1/12

(57) ABSTRACT

An interface (8) for attaching a tool or a payload (9) to an Unmanned Aerial Vehicle, UAV (1), the interface having, on a tool or payload side of the interface, at least one first connecting element (8a) for connecting a tool or payload to the interface on said tool or payload side thereof, and on a vehicle side of the interface, at least one second connecting element (8b) for connecting the interface to an UAV on the vehicle side thereof. At least one sensor unit (8c) configured to measure at least one physical property of the tool or payload, when it is connected to the interface, and at least one control unit (8d) in operative connection with the at least one sensor unit. The control unit is configured to communicate with a flight control unit (6) of the UAV for providing it with data related to the measured at least one physical property.

### INCORPORATION BY REFERENCE

The following documents are incorporated herein by reference as if fully set forth: European Patent Application No. 19 191 889.5, filed Aug. 15, 2019.

### TECHNICAL FIELD

The invention relates to an interface for attaching a tool or a payload to an Unmanned Aerial Vehicle, UAV.

The invention further relates to an Unmanned Aerial Vehicle, UAV. In the present description, the UAV is also referred to as an aircraft.

The invention further relates to a tool or payload for use with an Unmanned Aerial Vehicle, UAV.

The invention further relates to a system of an Unmanned Aerial Vehicle, UAV, and an interface for attaching a tool or a payload to said UAV.

The invention also relates to a method of operating an Unmanned Aerial Vehicle, UAV.

### BACKGROUND

There is currently no community-wide accepted tool or payload interface for UAS (Unmanned Aerial Systems) or UAV (Unmanned Aerial Vehicles), i.e., drones or the like, which shall hereinafter also and explicitly incorporate manned aircraft which navigate or can navigate in an automatic mode, meaning in a non-fully manual mode, e.g. with assistance from automation, either for stabilization, navigation or payload handling.

US 2018/244401A1 discloses a mechanical interface, which can be provided on a small fixed wing aircraft for carrying a device to catch uncooperative drones.

None of the three key interface types, i.e., mechanical, electrical and logical, has been brought to an industry standard in the field of UAV, such as heavy-duty drones, e.g., for delivery and logistics or use in agriculture. In particular, there is no generic interface which would allow the swapping of tools or payload between such civilian heavy-duty drones. Moreover, the impact of additional payload on the flight control unit of an UAV has never been addressed in a generic way.

There is a need for a unified generic tool or payload interface for heavy-duty drones (UAV) with industrial tools or payloads. The interface structure should provide a standardized physical interface, electric interface and logical interface between the payload and the aircraft. Additionally, the interface should enable to account for physical effects generated by the tool or payload for flight control of the UAV.

### SUMMARY

It is the object of the present invention to provide a unified generic tool or payload interface for heavy-duty drones (UAV) with industrial tools or payloads, a structure of which provides a standardized physical interface, electric interface and logical interface between the tool or payload and the aircraft. Additionally, the interface shall enable to consider physical effects of the tool or payload for flight control of the UAV.

This object is achieved by providing an interface having one or more features of the invention, by providing an UAV having the one or more features of the invention, by providing a tool or payload having one or more features of the invention, by providing a system of an Unmanned Aerial Vehicle, UAV, and an interface for attaching a tool or a payload to said UAV having one or more features of the invention, and by providing a method of operating an UAV having one or more features of the invention.

Advantageous further embodiments are defined below and in the claims.

According to a first aspect of the invention, an interface for attaching a tool or a payload to an Unmanned Aerial Vehicle, UAV, comprises: on a tool or payload side of the interface, at least one first connecting element (i.e., a physical connecting element) for connecting a tool or payload to the interface on said tool or payload side thereof;

on a vehicle side of the interface, at least one second connecting element (i.e., a physical connecting element) for connecting the interface to an UAV on said vehicle side thereof;

at least one sensor unit, which sensor unit is devised for measuring at least one physical property of a tool or payload, when said tool or payload is connected to the interface; and

at least one control unit in operative connection with said at least one sensor unit and with at least one data communication element (i.e., a logical connecting element), which control unit is devised for communicating with a flight control unit of the UAV for providing said flight control unit with data related to said measured at least one physical property via said at least one data communication element.

The one first (physical) connecting element can be either mechanical, electromechanical, electromagnetic or magnetic (or any combination thereof), as long as it is suitable for securely connecting a tool or payload to the interface on said tool or payload side thereof.

Likewise, the one second (physical) connecting element can be either mechanical, electromechanical, electromagnetic or magnetic (or any combination thereof), as long as it is suitable for securely connecting for connecting the interface to an UAV on said vehicle side thereof.

Preferably, the interface can comprise, as the first connecting element, a mechanical attachment with the tool or payload in the form of two standard aerospace rails or profiles, on which payload can be securely attached with a range of aerospace standard attachments that can be obtained off the shelf, e.g., a simple pin mechanism, which is simple and highly cost-efficient.

In a further embodiment of the interface according to the invention, the at least one second connecting element comprises a pin or bolt type connector. Applicant has found that this is a secure, yet efficient way of fastening the interface to a UAV, in particular to an aircraft's main airframe. Preferably, a plurality of such pins or bolts are arranged in flat polygonal structure, in particular four of them arranged in the form of a rectangle.

The at least one sensor unit can be of any type which is suitable for measuring at least one physical property of a tool or payload, when said tool or payload is connected to the interface. Preferably, in an embodiment of the interface according to the invention, the at least one sensor unit comprises a force sensor, e.g. a load cell, which can be used to measure a mass of the tool or payload. Furthermore, it becomes possible to measure the wrench (6D forces) of the payload, especially when providing more than one load cell. Further static quantities that can be measured with appropriate sensors are—without limitation—a projected surface of the payload in the forward flying direction, etc. Potential dynamic quantities that can be measured are—again without limitation—a force along a vertical or z-axis, and a moment of the tool or payload and of the interface around the roll and pitch axes of the aircraft. According to the invention, it becomes possible, via the at least one control unit of the interface in operative connection with said at least one sensor unit, to provide said data related to said measured at least one physical property (i.e., any of the aforementioned quantities) to a flight control unit of the UAV in order to take them into account for flight control of the UAV.

In a further embodiment of the interface according to the invention, the at least one control unit comprises power electronics, which power electronics are devised for adapting a power characteristic of the control unit to a power characteristic of the UAV and/or to a power characteristic of the tool or payload.

An electrical interface between the tool or payload and the interface on the one hand and the interface and the aircraft on the other hand can be realized using standard aerospace connectors or cables. Power characteristics and specifications should encompass standard (power) ranges, and said power electronics serve to make the aircraft and the payload match electrically, e.g., in terms of available voltage. Alternatively, a fixed power specification could be given, which would eliminate the need for providing power electronics. However, this would force both aircraft and tool or payload manufacturers to comply, which may be an issue.

In a further embodiment of the interface according to the invention, the at least one control unit comprises a (basic) input/output (I/O) or a more complex logical interface unit adapted for providing data related to said measured at least one physical property to the UAV for triggering at least one tool or payload related function. In this context, the interface preferably just provides (sensor) information which can be used to trigger actions or functions under control of the UAV's internal logic.

In a preferred embodiment, said functionality can comprise an emergency dropping of the tool or payload, e.g., by activating/deactivating an actuated (automated) locking mechanism. Further, the same automated locking mechanism could also be implemented to attach the payload or tool to the UAV. A correct positioning of the payload or tool in relation to the UAV or the interface can be realized by an external manual or automated system.

For instance, an actuated locking mechanism can be part of the mechanical (physical) interface with the tool or payload, i.e., the at least one first connecting element for connecting a tool or payload to the interface on said tool or payload side thereof. Such actuated locking mechanism can be devised to consume only little power and can be used to simplify tool or payload handling. It can also provide a quick release mechanism in case of inflight tool or payload malfunction. In this way, it allows for automated tool or payload release during flight, if the mission requires. For example, payload can be dropped on difficult/impossible landing area.

In this way, a logical interface, through which the control unit is devised for communicating with a flight control unit of the UAV for providing said with data related to said measured at least one physical property, can comprise only very basic I/O (input/output) in order to trigger a given functionality of the aircraft, e.g., the above-described emergency dropping of the tool or payload.

A simple I/O (input/output) logical interface can be used to also trigger payload functionality or to provide information (data) about payload parameters, for example, a sprayer (spraying on/off), tank (full/empty), or a sling load hook (open/close).

As the data from the sensor unit, at least in a preferred embodiment, is shared with the aircraft, the logical interface in that case needs to be more complex than just I/O in order to be able to transmit estimated weight, current forces and moments of the tool or payload. A more complex logical interface (like a data bus or a serial connection) can also embed messages with the simple I/O. Preferably, any interface is devised in such a way that only one single standardized small cable has to be plugged to the aircraft for achieving the connection.

In a corresponding embodiment of the interface according to the invention, the interface further comprises at least one data communication element (i.e., a logical interface), which can be either wired (e.g., a plug connector) or wireless (e.g., an antenna), in operative connection with said control unit for at least receiving status data from a tool or payload connected to the interface.

In another embodiment of the interface according to the invention, the at least one control unit comprises a computational unit, preferably a low power computational unit or a computer, which computational unit is devised for employing a more sophisticated communication protocol enabling to exchange status information between the UAV and the tool or payload.

This requires a more advanced logical interface together with said communication protocol in order to be able to exchange status data and information between the aircraft and the tool or payload. In the above-defined embodiment, such advanced logical interface is provided in order to be able to communicate between the interface and the aircraft. In order to manage the communication, said computational unit, preferably a low power computational unit or computer, can be integrated in the interface.

The interface can also comprise a one electrical energy supply unit, e.g. a battery or another source of electrical energy in order to make the interface and the tool or payload independent from the aircraft in terms of power. This ensures that the tool or payload does not drain power from the aircraft (and its propulsion train, which generally is electrically powered) even if the tool or payload itself is not self-powered. Power management for the tool or payload can be advantageously incorporated in the interface computer, i.e. said computational unit. Alternatively, or additionally, there can be an electrical energy supply unit, e.g. a battery or another source of electrical energy comprised in the tool or payload.

In a corresponding embodiment of the interface according to the invention, there is provided at least one electrical energy supply unit, preferably a secondary (rechargeable) battery unit, for supplying electrical energy to any electrical energy consuming unit comprised in the interface according to the invention and/or to a tool or payload, in particular but not limited to the interface computer, the sensor unit(s), the actuated locking mechanism and the tool or payload itself.

In yet another embodiment of the interface according to the invention, there is provided a human machine interface on the interface in connection with a database for choosing, from said database, payload- or tool-specific data for transmission to a flight control unit of an UAV, wherein preferably the human machine interface comprises a touchpad or display with input means (e.g. buttons) for inputting and/or selecting (e.g. from said database) tool/payload data, such as e.g. weight, dimensions, etc., and/or for displaying the status of a battery or energy source of the tool or payload, and/or for triggering a functionality of the tool for test before flight.

According to a second aspect of the invention, an Unmanned Aerial Vehicle, UAV, comprises: a main airframe; at least one propulsion unit devised for moving the UAV attached to said main airframe; at least one flight control unit for controlling said at least one propulsion unit and optionally an additional steering unit for controlling a movement of the UAV; at least one tool or payload connecting element attached to said main airframe, said tool or payload connecting element being devised for connecting with the interface according to said first aspect of the invention on the vehicle side thereof; and at least one data communication element for at least inputting input data received from said interface into said least one flight control unit. The at least one data communication element can be either wired (e.g., a plug) or wireless (e.g., an antenna).

In a further embodiment of the UAV according to the invention, said least one flight control unit is devised for controlling said at least one propulsion unit and optionally an additional steering unit, e.g., a flap or a tiltable wing, for controlling a movement of the UAV based on said input data.

In order to be able to use the above-described advantages with a particular tool or payload there is provided, according to a third aspect of the invention, a tool or payload for use with an Unmanned Aerial Vehicle, UAV, comprising: a tool or payload body; at least one interface connecting element (i.e., a physical connecting element) attached to said tool or payload body, said interface connecting element being devised for connecting with the interface according to said first aspect of the invention on the tool or payload side thereof.

Furthermore, in a preferred embodiment thereof, the tool or payload according to said third aspect of the invention further comprises at least one data communication element (e.g., a plug or an antenna) devised for providing an operative connection with said control unit of the interface for at least relaying status data from the tool or payload to the interface in a connected state. From the interface, said status data can then be passed on to the aircraft's flight control unit.

Said flight control unit (or flight controller) is a key element to enable a safe and stabilized flight in many aerial system designs. While aircraft manufacturers design the flight controller for a generic use and then re-tune them for specific tools or payloads, providing them directly with measured physical quantities from the tool or payload, as proposed by the present invention, can improve their efficiency and remove the need for payload specific tuning.

As already stated above, the sensor unit(s) comprised in the interface according to said first aspect of the invention can be used to share certain physical properties or quantities between the tool or payload, the interface and the aircraft. Potential static properties that can be shared are—without any limitation—the mass of the tool or payload, the inertia of the tool or payload, the projected surface of the tool or payload in the forward flying direction, etc. In an alternative embodiment, some of said properties of the tool or payload are calculated by the flight control unit, while the sensor unit only measures and transmits forces.

Potential dynamic quantities that can be shared (again without any limitation) are the force along the z-axis, and the moment of the tool or payload plus the interface around the roll and pitch axis of the aircraft.

These quantities can be used to feed a dynamical model of the aircraft used in the flight controller, thus significantly improving performances and removing the need for payload specific tuning. Physical quantities from the payload or tool can be embedded in the tool or interface and transmitted to the flight controller to improve the flight control performance.

In order to be fully able to use the above-described advantages in a combination of a UAV with a particular tool or payload, there is provided, according to a fourth aspect of the invention, a system of an Unmanned Aerial Vehicle, UAV, and an interface for attaching a tool or a payload to said UAV, wherein: said interface is devised as defined according to said first aspect of the invention; and said UAV is devised as defined according to said second aspect of the invention; wherein said interface is mechanically fastened or fastenable, preferably detachably fastened or fastenable, to said UAV; and wherein said interface and said UAV are operatively connected or connectable via said at least one data communication element of the UAV and said at least one data communication element of the interface.

In a further embodiment of the system according to said fourth aspect of the invention, the system further comprises: a tool or payload as devised according to a third aspect of the invention, said interface connecting element of the tool or payload being mechanically fastened or fastenable, preferably detachably fastened or fastenable, to said interface on said tool or payload side thereof; wherein preferably the interface and the tool or payload are operatively connected or connectable via at least one data communication element of the tool or payload.

In a further embodiment of the system according to said fourth aspect of the invention, said least one flight control unit is devised for providing a signal for changing a connecting state of said tool or payload between a first connecting state, in which first connecting state said tool or payload is or can be fastened to the interface, and a second connecting state, in which second connecting state said tool or payload is or can be detached from the interface. This has already been described in detail before. Said signal for changing a connecting state of said tool or payload can be used to activate an actuated locking mechanism, in particular for emergency release of the tool or payload or for triggering another functionality of the tool or payload, e.g. a spraying mechanism based on GPS coordinates (which would be triggered by the flight controller), activating lights attached to the tool/payload, activating/deactivating a hook on a cable, etc.

According to a fifth aspect of the invention, a method of operating an Unmanned Aerial Vehicle, UAV, in particular as defined according to said second aspect of the invention, comprises: connecting a tool or payload, in particular as defined according to said third aspect of the invention, to the UAV, using a tool or payload interface as defined according to said first aspect of the invention; providing the UAV, preferably repeatedly during operation, through said tool or payload interface with status data from said tool or payload connected to the interface and/with data from said tool or payload interface; and using said status data and/or said data in at least one flight control unit of the UAV for controlling an operation of the UAV and/or for controlling a connecting state of the tool or payload.

In the context of the present invention, sensor data supplied by the interface can be used to derive payload force and moment. An alternative method to recover these quantities would be through the use of advanced control techniques, namely so-called “observers”, which require a precise model of the aircraft and its aerodynamics, as well as a precise estimate of its full state (position, velocity, acceleration in 6D), to be able to reconstruct any external forces and moments. These external forces and moments would then comprise a mixture of influences of the payload, the wind and any unmodeled phenomena. However, the inherent complexity of this method and the imperfect precision achievable thereby make it an unlikely candidate for easy use in certified aircraft—unlike the present invention.

In yet another embodiment of the invention it is possible to have an HMI (human machine interface) on the interface for a payload-flight-controller-tuning; i.e. choosing from a database (within the interface) payload- or tool-specific data which then is transmitted to the flight control. For example, an external operator could choose, e.g. over a touchpad or display with buttons which tool/payload is now attached and the related tool/payload data, such as e.g. weight, dimensions, etc., are transmitted to flight controller. Also, if there is an electrical energy supply unit, e.g. a battery, inside the interface the status of the electrical supply unit could be displayed on such HMI. Furthermore, a functionality of the tool can be triggered for test before flight.

### BRIEF DESCRIPTION OF THE DRAWINGS

Additional features and advantages of the invention will now be described in detail with reference to the appended drawings.

FIG. 1 shows a UAV with attached interface and payload;

FIG. 2 shows a schematic block diagram of the UAV in FIG. 1; and

FIGS. 3A-3D show four detailed views of the interface alone.

### DETAILED DESCRIPTION

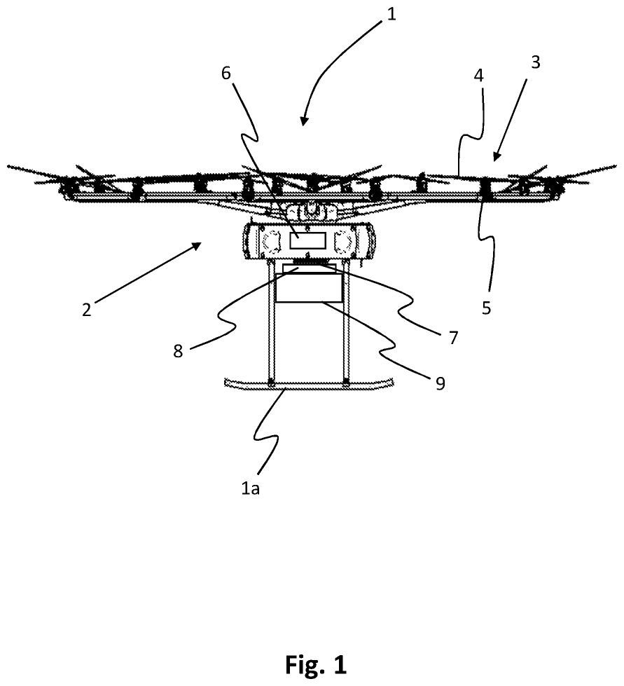

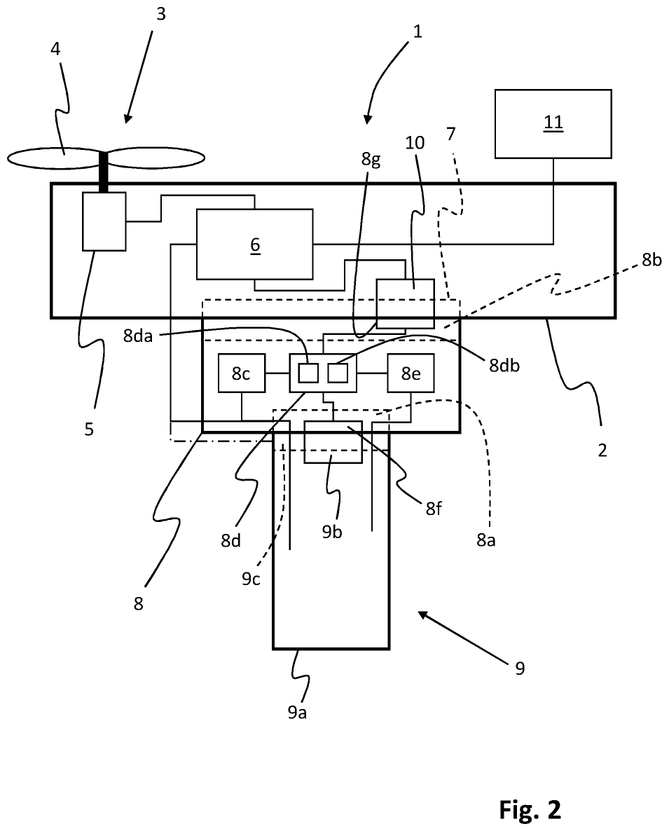

FIG. 1 shows a UAV or drone depicted at reference numeral 1. The UAV 1 comprises a main body or airframe 2 having a plurality of propulsion units 3, only one of which is marked explicitly. Each propulsion unit comprises a propeller (or rotor) 4 and an electrically powered motor unit 5 for driving said propeller 4. The propulsion units 3 are controlled by a flight control unit 6 comprised within said main body 2 (cf. FIG. 2 with further details). The main body 2 is fitted with a payload connecting element 7 to which is fastened an interface 8 for attaching payload 9, which will be detailed below with reference to FIG. 2. Reference numeral 1a denotes a landing gear.

In the following description, reference is made to a payload 9 only. However, the invention is not limited to any particular kind of payload 9. Said payload 9 could also take the form of a tool or any other object to be moved by UAV 1.

Interface 8 is mechanically fastened or fastenable, preferably detachably fastened or fastenable, to said UAV 1, and said interface 8 and said UAV 1 are operatively connected or connectable via at least one data communication element of the UAV which will be explained in more detail below with respect to FIG. 2. Payload 9 comprises an interface connecting element (FIG. 2) which is mechanically fastened or fastenable, preferably detachably fastened or fastenable, to said interface 8 on a payload side thereof. Furthermore, the interface 8 and the payload 9 are operatively connected or connectable via at least one data communication element of the payload which will also be explained in more detail below with respect to FIG. 2.

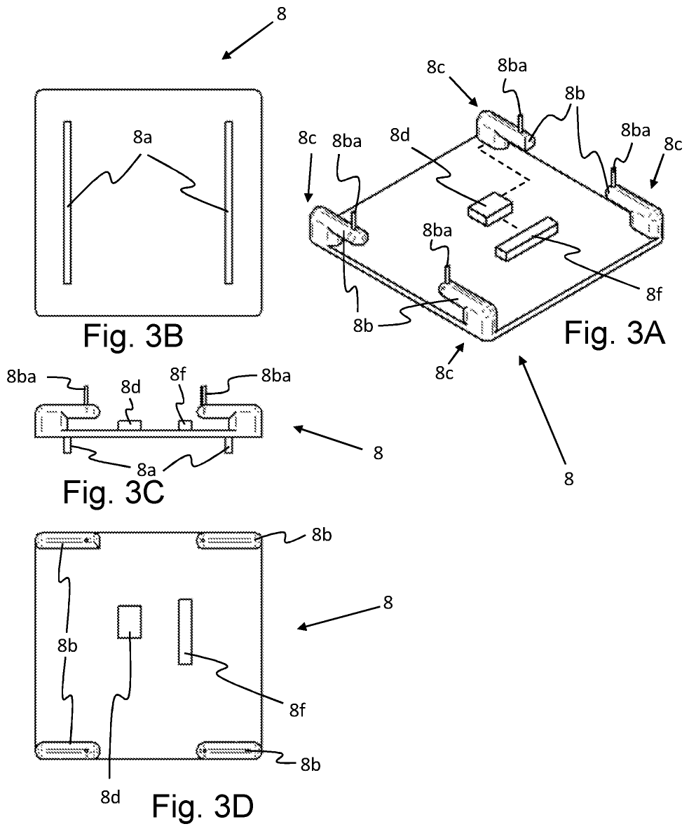

FIG. 2 shows a schematic block diagram of the UAV 1 in FIG. 1. Same reference numerals are used to designate same elements or elements having the same function. The flight control unit 6 is in cooperative connection with motor 5. Interface 8 comprises, on a payload side of the interface 8, at least one first connecting element 8a for physically connecting the payload 9 to the interface 8 on said payload side thereof. Interface 8 further comprises, on a vehicle side thereof, at least one second connecting element 8b for physically connecting the interface 8 to the UAV 1, i.e., the UAV main body 2, on said vehicle side thereof. The at least one second connecting element 8b is the mechanical counterpart of payload connecting element 7. The at least one second connecting element 8b can comprise a pin or bolt type connector, as will become apparent from FIGS. 3A-3D. Interface 8 further comprises at least one sensor unit 8c, which sensor unit 8c is devised for measuring at least one physical property of the payload 9, when said payload 9 is connected to the interface 8. Preferably, said sensor 8c unit comprises a load cell. More preferably, a plurality of sensor units 8c (e.g., load cells) are arranged in a (flat) polygonal pattern (cf. FIGS. 3A-3D). Reference numeral 8d denotes an interface control unit which is in operative connection with said at least one sensor unit 8c. Control unit 8d is devised for communicating with the flight control unit 6 of the UAV 1 for providing said flight control unit 6 with data related to said measured at least one physical property, so that said data can be used for controlling operation of the UAV 1.

Interface control unit 8d comprises power electronics 8da, which power electronics 8da are devised for adapting a power characteristic of the control unit 8d to a power characteristic of the UAV 1 and/or to a power characteristic of the payload 9, if the payload is (self-)powered, i.e., consumes electrical energy. Interface control unit 8d further comprises at least an logical interface unit 8db adapted for providing data related to said measured at least one physical property to the UAV 1 for triggering at least one tool or payload related function (e.g., a payload release mechanism). Preferably, however, the logical interface unit 8db is devised in the form of a computational unit, preferably a low power computational unit, i.e., a small computer, which computational unit is devised for employing a more sophisticated communication protocol enabling to exchange detailed status information between the UAV 1 (i.e., flight control unit 6) and the interface 8 and/or payload 9.

At reference numeral 8e, there is depicted an electrical energy supply unit, preferably a secondary battery unit, for supplying electrical energy to any electrical energy consuming unit comprised in the interface 8 (i.e., sensor unit 8c, control unit 8d, . . . ) and/or to the payload 9, if the latter is not self-powered. This avoids draining the UAV 1 in terms of electrical power, which is required for operating the flight control unit 6 and/or the propulsion units 3.

Furthermore, the interface 8 comprises at least one data communication element 8f in operative connection with said control unit 8d for at least receiving status data from the payload 9 connected to the interface 8. Payload 9 comprises a payload (main) body 9a having at least one data communication element 9b devised for providing an operative connection with said control unit 8d of the interface 8 for at least relaying status data from payload 9 to the interface 8 in a connected state. Said data communication element 9b is the counterpart of data communication element 8f and devised for connecting with the interface 8 (i.e., with said data communication element 8f) on a payload side thereof. Likewise, UAV 1 comprises at least one data communication element 10 for at least inputting input data received from interface 8 into flight control unit 6. Data communication element 10 is the counterpart of at least one data communication element 8g of the interface 8 in operative connection with said control unit 8d for communicating with the flight control unit 6 of UAV 1. In this way, said flight control unit 6 can be provided with data related to said at least one physical property measured by sensor unit 8c.

Payload body 9a further comprises at least one interface connecting element 9c attached to said payload body 9a, said interface connecting element 9c being devised for connecting with the interface 8 on said payload side thereof. Interface connecting element 9c is the (mechanical) counterpart of said least one first connecting element 8a described further up.

Reference numeral 11 depicts an optional steering unit (e.g., a wing or flap) for controlling a movement of the UAV 1 by means of control signals from flight control unit 6. In this way, said data provided to flight control unit 6 from interface 8 can be further used for controlling operation of the UAV 1.

As shown further in FIG. 2, flight control unit 6 of UAV 1 is advantageously directly connected operatively with said least one first connecting element 8a for connecting the payload 9 to the interface 8 (solid line) and/or with (dashdotted line) said at least one interface connecting element 9c attached to said main payload body 9a. Both said connecting elements 8a, 9c can be devised as actuated locking mechanisms which can be actuated by means of a suitable control signal (from flight control unit 6). In this way, if flight control unit 6, based on the payload related data relayed by payload 9 itself and/or by sensor unit 8c (via interface control unit 8d), decides that a mission cannot be (safely) completed with payload 9 attached to the UAV, it may actuate connecting elements 8a and/or 9c in order to drop payload 9—for instance in case of an emergency or in case of a terrain unsuitable for landing in order to deliver payload 9.

In this way, there is provided a method of operating an Unmanned Aerial Vehicle, UAV 1, wherein the flight control unit 6 is devised for providing a signal for changing a connecting state of said payload 9 between a first connecting state, in which first connecting state said payload 9 is or can be fastened to the interface 8, and a second connecting state, in which second connecting state said payload 9 is or can be detached from the interface 8.

Furthermore, there is provided a method of operating an Unmanned Aerial Vehicle, UAV 1, which method comprises connecting a payload 9 to an UAV 1, using the interface 8 as defined above, providing the UAV 1, preferably repeatedly during operation thereof, through said interface 8 with status data from the payload 9 connected to the interface 8 and/with data measured by said interface 8 (i.e., sensor unit 8c); and using said status data and/or said data in the flight control unit 6 of the UAV 1 for controlling an operation of the UAV 1 and/or for controlling a connecting state of the payload 9.

FIGS. 3A-3D show various views of a particular kind of interface 8.

FIG. 3A is a perspective view of interface 8 which takes on the overall form of a square plate (without limitation). As can be gathered from FIG. 3A, the at least one second connecting element 8b for connecting the interface 8 to the UAV 1, i.e., the UAV main body 2 (FIGS. 1, 2) is devised in the form of four hook-shaped projections extending from the interface plate, each projection comprising a pin or bolt 8ba for mechanical interaction with counterpart payload connecting element 7 (FIG. 2). All pins 8ba are arranged in a common plane parallel to the interface plate. A load cell (not shown as such), which forms a sensor unit 8c (FIG. 2), can be integrated in each of the hook-shaped projections. With said pins 8ba, the interface 8 can be secured to the UAV through said load cells fastened to both interface 8 and UAV via four anchor points. In this realization, the force and moment of the payload can be measured directly on the four anchoring points. Please do also refer to FIG. 3D (top view) in this context. Control unit 8d is operative connected with all load cells, which is only depicted for one of the load cells in FIG. 3A.

The first connecting element 8a for connecting a payload to the interface 8 on a payload side thereof is devised in the form of two aerospace standard profiles or rails located parallel to each other on a side of the interface plate opposite said hook-shaped projections, cf. FIGS. 3B (bottom view) and 3C (side view). On said profiles or rails, any payload can be simply and securely attached with a range of aerospace standard attachments that can be obtained off the shelf, e.g., a simple pin mechanism.

1. An interface (8) for attaching a tool or a payload (9) to an Unmanned Aerial Vehicle, UAV (1), comprising:
at least one first connecting element (8a) for connecting a tool or payload (9) to the interface (8) on a tool or payload side thereof;
at least one second connecting element (8b) for connecting the interface (8) to an UAV (1) on a vehicle side of said interface (8);
at least one sensor unit (8c) configured to measure at least one physical property of the tool or payload (9), upon said tool or payload (9) being connected to the interface (8);
at least one control unit (8d) in operative connection with said at least one sensor unit (8c) and with at least one data communication element (8g), said control unit (8d) is configured to communicate with a flight control unit (6) of the UAV (1) for providing said flight control unit (6) with data related to said measured at least one physical property via said at least one data communication element (8g).

2. The interface (8) of claim 1, wherein
the at least one sensor unit (8c) comprises at least one of a force sensor or a load cell.

3. The interface (8) of claim 1, wherein
the at least one second connecting element (8b) comprises a pin or bolt type connector.

4. The interface (8) of claim 1, wherein
the at least one control unit (8d) comprises power electronics (8da), said power electronics (8da) are configured to adapt a power characteristic of the control unit (8d) to at least one of a power characteristic of the UAV (1) or a power characteristic of the tool or payload (9).

5. The interface (8) of claim 1, wherein
the at least one control unit (8db) comprises a logical interface unit (8db) configures to provide data related to said measured at least one physical property to the UAV (1) to trigger at least one tool or payload related function.

6. The interface (8) of claim 1, wherein
the at least one control unit (8d) comprises a computational unit (8db), said computational unit (8db) is configured with a communication protocol enabling an exchange status information between the UAV (1) and the tool or payload (9).

7. The interface (8) of claim 1, further comprising:
at least one electrical energy supply unit (8e) configured to supply electrical energy to any electrical energy consuming unit comprised in at least one of the interface (8) or to the tool or payload (9).

8. The interface (8) of claim 1, further comprising:
at least one of a data communication element (8f) in operative connection with said control unit (8d) and configured to at least receive status data from the tool or payload (9) connected to the interface (8) or a data communication element (8g) in operative connection with said control unit (8d) and configured to communicate with a flight control unit (6) of an UAV (1) for providing said flight control unit (6) with data related to said measured at least one physical property.

9. The interface (8) of claim 1, further comprising:
a human machine interface on the interface (8) in connection with a database for choosing, from said database, payload- or tool-specific data for transmission to a flight control unit (6) of an UAV (1), wherein the human machine interface comprises a touchpad or display with an input configured to allow at least one of an input or selection, from said database, tool/payload data including at least one of a weight or dimensions, displaying a status of an electrical energy supply unit of the tool or payload or the interface, or for triggering a functionality of the tool for test before flight.

10. An Unmanned Aerial Vehicle, UAV (1), comprising:
a main airframe (2);
at least one propulsion unit (3) configured for moving the UAV (1) and attached to said main airframe (2);
at least one flight control unit (6) configured to control said at least one propulsion unit (3) and optionally an additional steering unit (11) for controlling a movement of the UAV (1);
at least one tool or payload connecting element (7) attached to said main airframe (2), said tool or payload connecting element (7) being configured to connect with the interface (8) according to claim 1 on the vehicle side thereof;
at least one data communication element (10) configured for at least inputting input data received from said interface (8) into said least one flight control unit (6).

11. The UAV (1) of claim 10, wherein
said least one flight control unit (6) is configured to control said at least one propulsion unit (3) and optionally an additional steering unit (11) for controlling a movement of the UAV (1) based on said input data.

12. A tool or payload (9) for use with an with an Unmanned Aerial Vehicle, UAV (1), the tool or payload comprising:
a tool or payload body (9a);
at least one interface connecting element (9c) attached to said tool or payload body (9a), said interface connecting element (9c) being configured to connect with the interface (8) according to claim 1 on the tool or payload side thereof.

13. The tool or payload (9) of claim 12, further comprising:
at least one data communication element (9b) configured to provide an operative connection with said control unit (8d) of the interface (8) for at least relaying status data from the tool or payload (8) to the interface (8) in a connected state.

14. A system of an Unmanned Aerial Vehicle, UAV (1), and the interface (8) according to claim 1 for attaching a tool or a payload (9) to said UAV (1), wherein:
said UAV (1) including a main airframe (2), at least one propulsion unit (3) configured for moving the UAV (1) and attached to said main airframe (2), at least one flight control unit (6) configured to control said at least one propulsion unit (3) and optionally an additional steering unit (11) for controlling a movement of the UAV (1), at least one tool or payload connecting element (7) attached to said main airframe (2), said tool or payload connecting element (7) being configured to connect with the interface (8) on the vehicle side thereof, and at least one data communication element (10) configured for at least inputting input data received from said interface (8) into said least one flight control unit (6);
wherein said interface (8) is mechanically fastened or fastenable to said UAV (1); and
wherein said interface (8) and said UAV (1) are operatively connected or connectable via said at least one data communication element (10) of the UAV (1) and said at least one data communication element (8g) of the interface (8).

15. The system of claim 14, further comprising:
a tool or payload (9) including a tool or payload body (9a), and at least one interface connecting element (9c) attached to said tool or payload body (9a), said interface connecting element (9c) being configured to connect with the interface (8) on the tool or payload side thereof, said interface connecting element (9c) of the tool or payload (9) being mechanically fastened or fastenable to said interface (8) on said tool or payload side thereof;
wherein the interface (8) and the tool or payload (9) are operatively connected or connectable via at least one data communication element (9b) of the tool or payload (9).

16. The system of claim 15, wherein
said least one flight control unit (6) is configured to provide a signal for changing a connecting state of said tool or payload (9) between a first connecting state, in which first connecting state said tool or payload (9) is fastened or fastenable to the interface (8), and a second connecting state, in which second connecting state said tool or payload (9) is detached or detachable from the interface (8).

17. A method of operating an Unmanned Aerial Vehicle, UAV (1), as claimed in claim 10, comprising:
connecting a tool or payload (9) to the UAV (1), using the interface (8);
providing the UAV (1) during operation via said interface (8) with at least one of status data from said tool or payload (9) connected to the interface or data from said interface (8); and
using the at least one of said status data or said data in at least one flight control unit (6) of the UAV (1) for at least one of controlling an operation of the UAV (1) or controlling a connecting state of the tool or payload (9).
